(19) United States
(12) Patent Application Publication
(10) Pub. No.: US 2026/0071652 A1
(43) Pub. Date: Mar. 12, 2026

(54) LINEAR ROLLER PROFILE RAIL GUIDE WITH A PLURALITY OF PARALLEL CIRCULATING ROWS OF ROLLERS TO REDUCE STROKE PULSATIONS

(71) Applicant: Schneeberger Holding AG, Roggwil (CH)

(72) Inventors: Marcel JUENGLING, Ispringen (DE); Konstantin NETZ, Bad Wildbad (DE); Thomas DANN, Karlsbad (DE)

(73) Assignee: Schneeberger Holding AG, Roggwil (CH)

(21) Appl. No.: 19/315,943

(22) Filed: Sep. 2, 2025

(30) Foreign Application Priority Data
Sep. 9, 2024 (EP) 24199349.2

(51) Int. Cl. F16C 29/06; F16C 29/00

(52) U.S. Cl. CPC F16C 29/065; F16C 29/005

(57) ABSTRACT

A linear roller profile rail guide includes a profile guide rail with at least four roller running track surfaces and a guide carriage moveable in the longitudinal direction of the rail with at least four roller running track surfaces formed on a main body. At least four full complement roller deflection devices are arranged on the guide carriage, each for rows of rollers arranged next to each other. In a roller circulation channel of one roller deflection device, when the guide carriage moves in the longitudinal direction of the rail, the rollers of first and second rows of rollers circulate next to each other along a ring-shaped closed roller orbit respectively parallel to a predetermined first plane. A separating web is arranged in the roller circulation channel of the respective roller deflection device, which extends between the first and second rows and spatially separates first from second row rollers.

### CROSS REFERENCE TO RELATED APPLICATIONS

Applicant claims priority under 35 U.S. C. § 119 of European Application No. 24199349.2 filed Sep. 9, 2024, the disclosure of which is incorporated by reference.

### BACKGROUND OF THE INVENTION

### 1. Field of the Invention

The invention relates to a linear roller profile rail guide, in particular, to a linear roller profile rail guide with a profile guide rail, which comprises at least four flat roller running track surfaces extending in a longitudinal direction of the profile guide rail, and comprising a guide carriage that can be moved linearly in the longitudinal direction of the profile guide rail, which comprises a main body, on which at least four flat roller running track surfaces extending in the longitudinal direction of the profile guide rail are formed.

### 2. Description of the Related Art

Linear roller profile rail guides of the type mentioned above have numerous applications, including for the precise and fast positioning of items, among other things.

The guide carriage is mounted on the profile guide rail by means of rollers. In order to enable a linear movement of the guide carriage in the longitudinal direction of the guide rail, the guide carriage is provided with a plurality of (at least four) roller deflection devices, each of which comprises a roller circulation channel extending in a ring shape, which roller circulation channel defines a ring-shaped closed roller orbit. In the roller circulation channel, a row of rollers is generally arranged in such a way that the rollers of the respective row of rollers are successively moved through the roller circulation channel when the guide carriage is moved in the longitudinal direction of the profile guide rail so that the rollers circulate along the ring-shaped closed roller orbit of the respective roller deflection device.

In a linear movement of the guide carriage in the longitudinal direction of the profile guide rail, the rollers circulate through different sections of the roller circulation channel, in which the rollers are each exposed to different levels of mechanical loads. The rollers of a roller deflection device pass successively, for example, through a first section of the roller circulation channel, which is delimited by one of the roller running track surfaces of the profile guide rail and one of the roller running track surfaces of the main body, which extends (essentially) parallel to the respective one of the roller running track surfaces of the profile guide rail. The rollers, which are currently located in this first section of the roller circulation channel, are each exposed to a relatively large level of mechanical load, since the diameter of the rollers is chosen in such a way that the rollers are clamped between the roller running track surface of the profile guide rail and the roller running track surfaces of the main body, which delimit the first section of the roller circulation channel, and are therefore under mechanical stress. The first section of the roller circulation channel mentioned above is therefore also referred to as the “load zone” of the roller circulation channel or the “load-bearing” zone of the roller circulation channel. The rollers which are currently circulating outside the first section of the roller circulation channel mentioned above, on the other hand, are not exposed to any mechanical loads. The area of the roller circulation channel that is outside the “load zone” of the roller circulation channel is therefore also referred to as the “unloaded”zone.

Linear roller profile rail guides of the above type have the characteristic that they are suitable for applications in which the guide carriage has to absorb a high level of load perpendicular to the longitudinal axis of the profile guide rail. Furthermore, the at least four roller deflection devices can be arranged relative to each other in such a way that the guide carriage can absorb high levels of load in any direction perpendicular to the longitudinal axis of the profile guide rail.

Linear roller profile rail guides of the above-mentioned usually show so-called “stroke pulsations” of the guide carriage when the guide carriage is moved in the longitudinal direction of a guide rail. “Stroke pulsations” are micro-movements of the guide carriage in the form of lifting and lowering movements perpendicular to the longitudinal direction of the guide rail, which occur periodically when the guide carriage moves in the longitudinal direction of the guide rail depending on the distance travelled in the longitudinal direction of the guide rail. A major cause of such stroke pulsations is to be seen in the fact that the guide carriage is currently supported on the guide rail exclusively by those rollers which are currently in the load zone of the roller circulation channel of the respective roller deflection devices of the guide carriage, and that the rollers in the load zones of the respective roller circulation channels are usually always subjected to mechanical preload. Due to this mechanical preload of the rollers, the main body of the guide carriage and the guide rail also show elastic deformations locally in the vicinity of the rollers located in the load zones of the respective roller circulation channels. When the guide carriage is moved in the longitudinal direction of the guide rail, the rollers circulate in the roller circulation channels of the respective roller deflection devices in such a way that the rollers of one of the rows of rollers pass through the load zone of a roller circulation channel successively in one direction so that, continuously at one end of the load zone, individual rollers enter the load zone successively from the unloaded zone of the roller circulation channel, while, at the other end of the load zone, individual rollers must continuously leave the load zone successively in order to re-enter the unloaded zone of the roller circulation channel. Therefore, when the guide carriage moves in the longitudinal direction of the guide rail, the number of rolling elements that are currently in the load zone of one of the roller circulation channels is not constant but varies periodically as a function of the distance travelled by the guide carriage. This variation in the number of rollers currently in the load zones of the roller circulation channels has the consequence that when the guide carriage moves in the longitudinal direction of the guide rail, the local elastic deformations of the main body of the guide carriage and the guide rail in the vicinity of the load zones of the roller circulation channels change periodically. These periodic changes in the elastic deformations of the main body of the guide carriage and the guide rail ultimately have the effect that any point of the guide carriage performs measurable periodic lifting and lowering movements (“stroke pulsations”) transversely to the longitudinal direction of the guide rail when the guide carriage moves in the longitudinal direction of the guide rail.

Such stroke pulsations of the guide carriage can have an amplitude of approx. 1-2 μm with conventional roller profile rail guides. Stroke pulsations of this magnitude can limit the positioning accuracy of the roller profile rail guide in such a way that the stroke pulsations affect the usability of the roller profile rail guide in a number of applications, such as applications for positioning tools for high-precision machining of surfaces of workpieces, for example, for producing smooth flat surfaces by grinding parts for low-noise gearboxes for applications in electromobility. Accordingly, there is a need to reduce stroke pulsations to a large extent.

A simple concept to reduce the amplitude of the stroke pulsations in a roller profile rail guide with rollers of a specified size is to increase the length of the guide carriage and the lengths of the load zones of the roller circulation channels so that the number of rollers that are simultaneously in the load zone of a roller circulation channel is increased. This concept is limited in that in many cases requirements for the space available with regard to the arrangement of the guide carriage have to be taken into account, which would not allow the choice of a longer length of the guide carriage.

If the choice of a longer length of the guide carriage (or the choice of a longer length of the load zone of a roller circulation channel) is not possible or desirable, an alternative concept for reducing the stroke pulsations can be to design the respective roller deflection devices in such a way that a plurality of (e.g., two) rows of rollers are arranged next to each other in the roller circulation channel of a roller deflection device so that, when the guide carriage is moved in the longitudinal direction of the guide rail, a plurality of (e.g., two) rows of rollers circulate next to each other through the roller circulation channel and are accordingly moved next to each other through the load zone of the roller circulation channel.

For example, the publication DE 11 2012 003 767 B4 describes a roller profile rail guide in which both four roller running track surfaces of the guide rail as well as four roller running track surfaces of the guide carriage each comprise a circular-arc-shaped profile in a cross-section perpendicular to the longitudinal direction of the guide rail. One embodiment of this roller profile rail guide comprises four roller deflection devices, in each of which two rows of rollers are arranged next to each other and can circulate next to each other through a roller circulation channel. The rollers of the rows of rollers arranged next to each other are connected to each other with a belt made of synthetic resin so that rollers of one row of rollers are connected to rollers of the other row of rollers via the belt. The belt is needed to align the axes of rotation of the rollers of the two side-by-side rows of rollers relative to each other in different sections of the roller circulation channel. Furthermore, the belt keeps successive rollers of each of the two rows of rollers at a distance relative to each other. This profile roller deflection device has the disadvantage that the implementation of the belt is complex, and the belt is susceptible to wear.

Document JPH06300039 (A) describes a roller profile rail guide with four flat roller running track surfaces of the guide rail and four flat roller running track surfaces of the guide carriage. This roller profile rail guide comprises four roller deflection devices, in each of which two rows of rollers are arranged next to each other and can circulate next to each other through a roller circulation channel. In the present case, each of the roller deflection devices is designed to be a “full complement” roller deflection device, i.e., the rollers arranged in the roller circulation channel of a roller deflection device are not connected to each other by means of a belt or chain, and furthermore there are no technical means available to separate two consecutive rollers of one of the two rows of rollers from each other or to keep them at a distance. Accordingly, the rollers can circulate in the roller circulation channel in such a way that immediately successive rollers can touch each other on their shell surfaces. The two rows of rollers are arranged next to each other in the roller circulation channel in such a way that two rollers arranged next to each other touch each other at their front surfaces facing each other. This approach has the disadvantage that rollers arranged next to each other can interfere with each other when circulating through the roller circulation channel and, for example, block each other, which increases the wear of the rollers and reduces their service life.

US 2015/0159695 A1 discloses a linear roller profile rail guide with a linear profile rail and a guide carriage. This roller profile rail guide has four roller circulation channels, wherein in each of the roller circulation channels two rows of rollers are arranged next to each other and the rollers of these two rows of rollers circulate next to each other and parallel to a plane through the respective circulation channel when the guide carriage moves in the longitudinal direction of the profile rail. A plurality of separator elements are arranged in each of the roller circulation channels, wherein the individual separator elements are arranged one after another in a row in the respective roller circulation channel. Each of the separator elements is placed between the rollers arranged in the roller circulation channel so that a single separator element: separates at least two consecutive rollers of one of the two rows of rollers arranged in the respective roller circulation channel from each other or keeps at a distance from each other; separates from each other or keeps at a distance from each other at least two consecutive rollers of the other of the two rows of rollers arranged in the respective roller circulation channel; and separates one roller of each of the two rows of rollers arranged in the respective roller circulation channel from two rollers of the other of the two rows of rollers arranged in the respective roller circulation channel. Each individual separator element is coupled to at least two consecutive rollers of one of the two rows of rollers arranged in the respective roller circulation channels and to at least two consecutive rollers of the other two rows of rollers arranged in the respective roller circulation channels in such a way that when the guide carriage moves in the longitudinal direction of the profile rail, all separator elements are synchronously moved together with the rollers arranged in the respective roller circulation channel and in addition, the rollers of one of the two rows of rollers arranged in the respective roller circulation channel can only be moved synchronously with the rollers of the other of the two rows of rollers arranged in the respective roller circulation channel. Each individual separator element is shaped in such a way that it comprises a plurality of differently arranged sections: an insulation wall, which is placed between the two rows of rollers so that the insulation wall is in sliding contact with the front surface of a roller of one of the two rows of rollers arranged in the respective roller circulation channels and with the front surfaces of two rollers of the other of the two rows of rollers arranged in the respective roller circulation channels; a first separation section, which comprises two limbs connected to the insulation wall, which extend on a first side of the insulation wall so that the two limbs encompass a roller of one of the two rows of rollers arranged in the respective roller circulation channels in the area of the shell surface of the roller; a second separation section, which extends on a second side of the insulation wall (opposite the first separation section) in such a way that the second separation section extends between two consecutive rollers of the other of the two rows of rollers arranged in the respective roller circulation channels and separates these two rollers from each other. In this roller profile rail guide, the insulation wall of a separator element is connected to the first separation section and the second separation section. The presence of the first separation section and the second separation section of the respective separator element results in the roller deflection device of this roller profile rail guide not being designed to be a “full complement” roller deflection device. This result has the unfavorable effect that the maximum load-bearing capacity of the roller profile rail guide is reduced due to the presence of the respective separation sections. In addition, the implementation of a large number of separator elements in combination with a large number of rollers arranged in two rows in a roller circulation channel is time-consuming.

### SUMMARY OF THE INVENTION

The present invention is based on the problem of avoiding the mentioned disadvantages and to create a linear roller profile rail guide with a full complement roller deflection device for a plurality of rows of rollers arranged next to each other, which enables improved guidance of the rows of rollers arranged next to each other with less wear and tear on the rollers.

This task is solved by means of a linear roller profile rail guide with the features according to the invention.

The linear roller profile rail guide comprises a profile guide rail, which has at least four flat roller running track surfaces extending in one longitudinal direction of the profile guide rail, and a guide carriage, which is arranged in a linearly moveable manner in the longitudinal direction of the profile guide rail and comprises a main body on which at least four flat roller running track surfaces extending in one longitudinal direction of the profile guide rail are formed.

The roller running track surfaces of the profile guide rail and the roller running track surfaces of the main body are arranged relative to each other in such a way that one of the roller running track surfaces of the profile guide rail and one of the roller running track surfaces of the main body extend parallel to each other and are arranged opposite to each other at a distance from each other in such a way that one of the roller running track surfaces of the profile guide rail and the respective one of the roller running track surfaces of the main body delimit a load-bearing roller passage channel. The guide carriage comprises-for each of the load-bearing roller passage channels-one full complement roller deflection device for a plurality of rows of rollers arranged next to each other, the roller deflection device being assigned to the respective individual of the load-bearing roller passage channels, which roller deflection device is attached to the main body and comprises a roller circulation channel extending in a ring-shaped manner, which roller circulation channel defines a ring-shaped closed roller orbit for the plurality of rows of rollers arranged next to one another. The roller circulation channel of the roller deflection device comprises: a first section of the roller circulation channel, which is identical to the respective one of the load-bearing roller passage channels; a second section of the roller circulation channel, which extends at a distance from the first section of the roller circulation channel in the longitudinal direction of the profile guide rail; a third section and a fourth section of the roller circulation channel, wherein the third section of the roller circulation channel connects one of two opposite ends of the first section of the roller circulation channel to one of two opposite ends of the second section of the roller circulation channel, and the fourth section of the roller circulation channel connects the other one of the two opposite ends of the first section of the roller circulation channel to the other one of the two opposite ends of the second section of the roller circulation channel.

The roller deflection device assigned to the respective one of the load-bearing roller passage channels comprises at least a first row of rollers and a second row of rollers, wherein the first row of rollers and the second row of rollers each comprise a plurality of rollers arranged successively (one after another), and the first row of rollers and the second row of rollers are arranged next to each other in the roller circulation channel of the roller deflection device in such a way that when the guide carriage moves in the longitudinal direction of the profile guide rail, the rollers of the first row of rollers and the rollers of the second row of rollers circulate next to each other along the ring-shaped closed roller orbit through the roller circulation channel, each parallel to a predetermined first plane.

According to the invention, the full complement roller deflection device assigned to the respective one of the load-bearing roller passage channels comprises a separating web which is fixed relative to the main body and respectively extends in the roller circulation channel parallel to the first plane through the first section, the second section, the third section and the fourth section of the roller circulation channel and is arranged between the first row of rollers and the second row of rollers in such a way that the separating web spatially separates the rollers of the first row of rollers from the rollers of the second row of rollers. Each roller of the first row of rollers abuts a first lateral surface of the separating web with a front surface of the respective roller so that each roller of the first row of rollers rests against the first lateral surface of the separating web when the guide carriage moves in the longitudinal direction of the profile guide rail. Furthermore, each roller of the second row of rollers with a front surface of the respective roller abuts a second lateral surface of the separating web so that each roller of the second row of rollers is guided at the second lateral surface of the separating web when the guide carriage moves in the longitudinal direction of the profile guide rail.

According to this arrangement, a separating web is implemented in the roller circulation channel of the respective roller deflection device, which separates the at least two rows of rollers arranged in the roller circulation channel roller deflection device from each other. The rollers of the first row of rollers and the rollers of the second row of rollers can therefore circulate next to each other in the roller circulation channel parallel to the first plane through the roller circulation channel, without the rollers of the first row of rollers and the rollers of the second row of rollers coming into contact with each other at their front surfaces. That the separating web of the respective roller deflection device is arranged in a fixed position relative to the main body ensures that when the guide carriage moves in the longitudinal direction of the profile guide rail, the rollers of the first row of rollers and the rollers of the second row of rollers circulate next to each other along the ring-shaped closed roller orbit through the roller circulation channel in such a way that each of the rollers of the first row of rollers and each of the rollers of the second row of rollers is moveable in circulation along the ring-shaped closed roller orbit relative to the separating web (in particular, along the entire extension of the separating web in the longitudinal direction of the roller circulation channel relative to the separating web). Compared to the roller profile rail guide known from document JPH06300039 (A), the wear of the rollers is therefore reduced by implementing the separating web. Furthermore, the separating web serves as a lateral guide surface for the front surfaces of rollers of at least one of the plurality of rows of rollers. This feature allows the rollers to be guided with increased stability. One embodiment of the linear roller profile rail guide is designed in such a way that the separating web in the roller circulation channel of the roller deflection device is arranged in such a way that the separating web extends seamlessly over the entire length of the roller circulation channel along the ring-shaped closed roller orbit for the rows of rollers arranged next to each other. Upon moving the guide carriage in the longitudinal direction of the profile guide rail along the entire extension of the separating web in the longitudinal direction of the roller circulation channel, each roller of the first row of rollers can be moved relative to the separating web so that the roller respectively abuts the first lateral surface of the separating web with a front surface of the respective roller. Accordingly, upon moving the guide carriage in the longitudinal direction of the profile guide rail along the entire extension of the separating web in the longitudinal direction of the roller circulation channel, each roller of the second row of rollers can be moved relative to the separating web so that the roller of the second row of rollers is respectively guided at the second lateral surface of the separating web. This allows all rollers to be guided with the same separating web at a particularly high level of stability along the entire length of the ring-shaped closed roller orbit of the rollers.

One embodiment of the linear roller profile rail guide is designed in such a way that the main body comprises a first surface region, which extends along the first section of the roller circulation channel parallel to the first plane in such a way that rollers of the first row of rollers in the first section of the roller circulation channel with a front surface of the respective roller remote from the separating web abut the first surface region of the main body and are guided at the first surface region of the main body in the case of a movement of the guide carriage in the longitudinal direction of the profile guide rail.

In this embodiment, the first surface region of the main body ensures that the rollers of the first row of rollers in the first section of the roller circulation channel, i.e., in the load zone of the roller circulation channel, can be guided laterally on the first surface region of the main body at a high level of stability. Because the rollers of the first row of rollers are placed on the separating web with a front surface, the lateral guidance of the first row of rollers on the first surface region of the main body also indirectly stabilizes the spatial position of the separating web and thus enables the second row of rollers to be guided on the separating web with improved stability.

Another embodiment of the linear roller profile rail guide is designed in such a way that the roller deflection device is composed of a plurality of individual parts and the separating web comprises a plurality of sections, wherein

one of the individual parts comprises a section of the separating web which extends across at least part of the length of the first section of the roller circulation channel, and/or

one of the individual parts comprises a section of the separating web extending over at least part of the length of the second section of the roller circulation channel, and/or

one of the individual parts comprises a section of the separating web which extends across at least part of the length of the third section of the roller circulation channel, and/or

one of the individual parts comprises a section of the separating web extending over at least part of the length of the fourth section of the roller circulation channel.

In this way, the implementation of a separating web over the entire length of the roller circulation channel is simplified. For example, different sections of the separating web can be realized for different sections of the roller circulation channel with different materials. Parts of the roller deflection device and sections of the separating web, for example, can be manufactured cost-effectively from plastic, for example, by injection molding.

One embodiment of the linear roller profile rail guide is designed in such a way that each of the rollers is designed to be rotationally symmetrical with respect to a longitudinal axis of the respective roller, and each roller comprises a diameter with respect to the longitudinal axis of the roller, which varies in the direction of the longitudinal axis of the roller so that the diameter of the roller comprises a maximum value in a middle area between opposite front surfaces of the roller and the diameter —starting from the middle area between the opposite front surfaces—in the direction of the longitudinal axis of the roller exhibits a steadily increasing reduction with the distance from the middle area as a function of a distance from the middle area. In addition, the separating web in the first section of the roller circulation channel of the roller deflection device extends parallel to the first plane in such a way that the separating web with respect to the one of the roller running track surfaces of the main body, which delimits the first section of the roller circulation channel of the roller deflection device, comprises a height less than the maximum value of the diameter of the rollers.

In this way, it is achieved that the separating web in the area of the load zone of the roller circulation channel can rest on the front surfaces of the rollers of the first row of rollers and on the front surfaces of the rollers of the second row of rollers across the entire surface of the respective front surfaces, without the separating web coming into contact with a roller running track surface formed on the profile guide rail.

A further embodiment of the linear roller profile rail guide is designed in such a way that the separating web extends in the first section of the roller circulation channel of the roller deflection device with reference to one of the roller running track surfaces of the main body, which delimits the first section of the roller circulation channel of the roller deflection device, in such a way parallel to the first plane that the separating web comprises an end section spaced away from the roller running track surfaces of the main body. In this case, the separating web comprises a first projection in the spaced-away end section, which extends perpendicular to the first plane in such a way that the first projection overhangs a roller of the first row of rollers abutting the first lateral surface of the separating web on an area of a shell surface of the roller abutting the first lateral surface of the separating web. In addition, the separating web comprises a second projection in the spaced-away end section, which extends perpendicular to the first plane in such a way that the second projection overhangs a roller of the second row of rollers abutting the second lateral surface of the separating web on an area of a shell surface of the roller abutting the second lateral surface of the separating web.

The arrangement of the first projection in the spaced-away end section of the separating web has the effect that the rollers of the first row of rollers located in the load zone of the roller circulation channel can be held on the guide carriage by means of the first projection when the guide carriage is removed from the profile guide rail.

Accordingly, the arrangement of the second projection in the spaced-away end section of the separating web has the effect that the rollers of the second row of rollers located in the load zone of the roller circulation channel can be held on the guide carriage by means of the second projection when the guide carriage is removed from the profile guide rail.

Another embodiment of the linear roller profile rail guide is designed in such a way that the separating web on the first lateral surface of the separating web comprises a first groove extending along the roller orbit (or along the roller circulation channel), through which first groove a lubricant for lubricating the rollers of the first row of rollers can be introduced into the roller circulation channel, and/or the separating web on the second lateral surface of the separating web comprises a groove extending along the roller orbit or along the roller circulation channel) through which second groove a lubricant for lubricating the rollers of the second row of rollers can be introduced into the roller circulation channel.

The first groove allows lubricant (e.g., lubricating oil or grease) to be distributed along the roller circulation channel to lubricate the first row of rollers. Accordingly, the second groove allows lubricant (e.g., lubricating oil or grease) to be distributed along the roller circulation channel to lubricate the second row of rollers.

Another embodiment of the linear roller profile rail guide is designed in such a way that the separator is made of plastic or at least a section of the separating web is made of plastic.

Plastics that ensure high rigidity and low friction coefficients, such as polyoxymethylene (also known as POM or polyacetals) for example, are particularly suitable as plastics.

Alternatively, it can be provided that a section of the separating web extending in the first section of the roller circulation channel is made of a metallic material, such as steel for example.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

### In the Drawings,

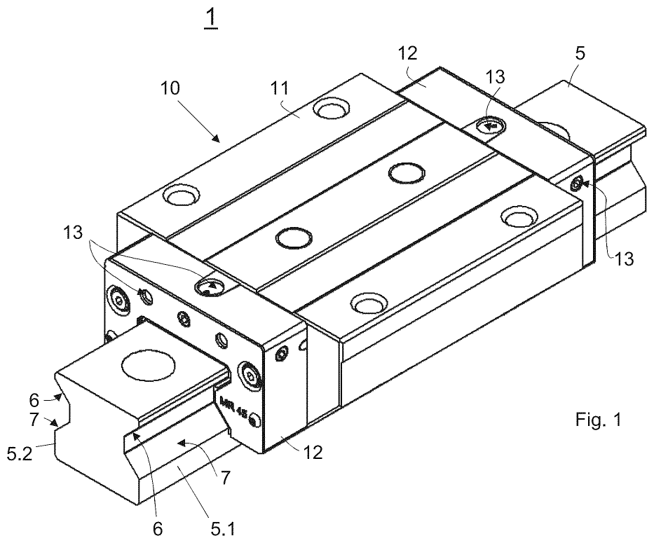

FIG. 1 shows a perspective view of a linear roller profile rail guide according to the invention with a profile guide rail and a guide carriage installed on the profile guide rail;

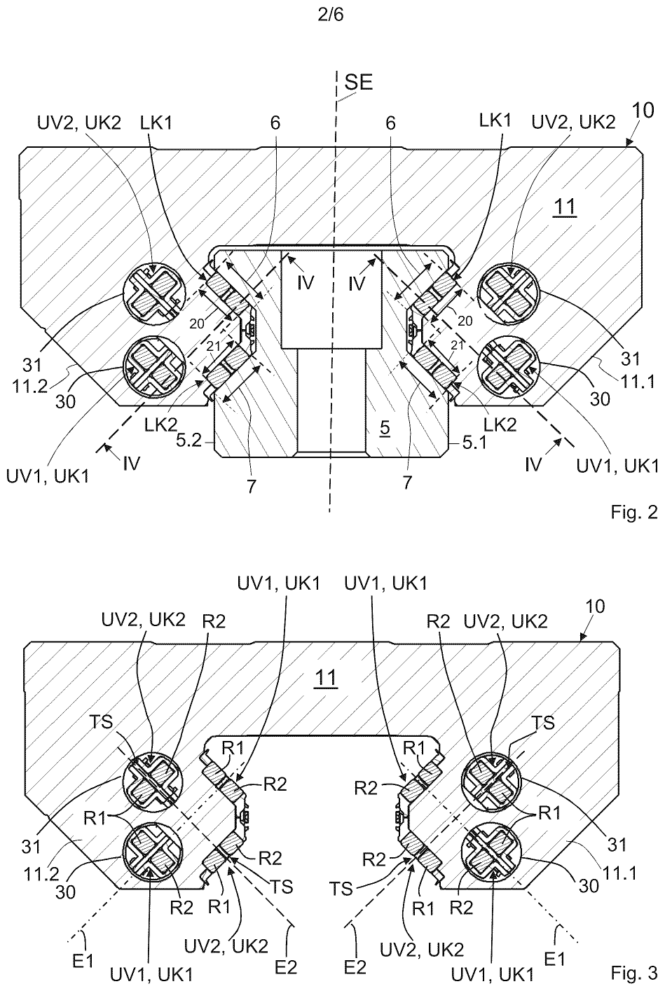

FIG. 2 shows the roller profile rail guide in accordance with FIG. 1 with an illustration of the profile guide rail and the guide carriage in a cross-section perpendicular to the longitudinal direction of the profile guide rail, for the illustration of portions of four roller deflection devices UV1 or UV2 for two rows of rollers arranged next to each other;

FIG. 3 shows the roller profile rail guide as shown in FIG. 2 but without the guide rail;

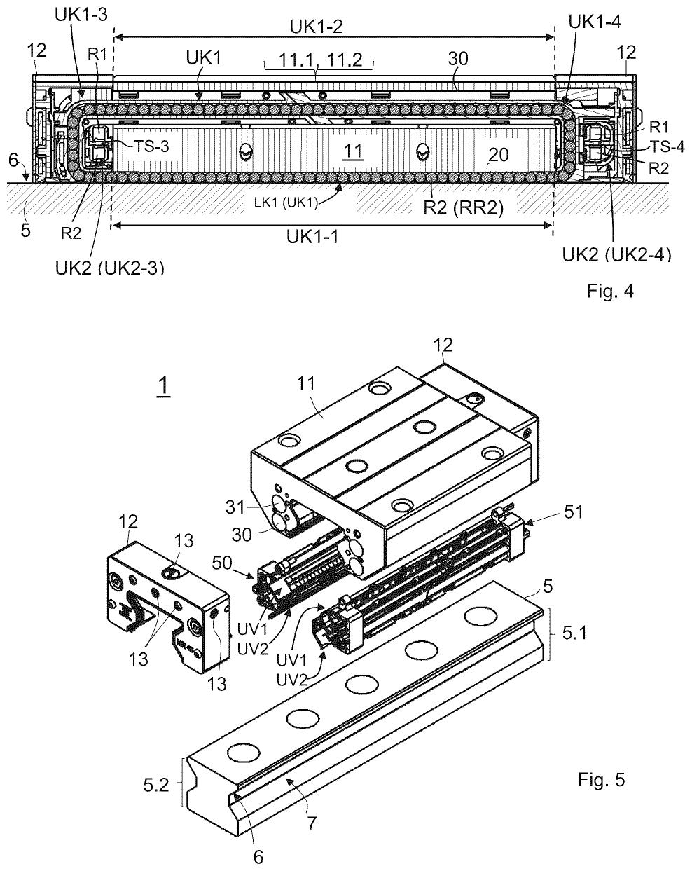

FIG. 4 shows a view of the roller profile rail guide in accordance with FIG. 1, in a longitudinal section through one of the lines IV-IV in FIG. 2, for the illustration of a roller circulation channel UK1 of a roller deflection device UV1 and a roller circulation channel UK2 of a roller deflection device UV2;

FIG. 5 shows a perspective view of the roller profile rail guide in accordance with FIG. 1 in an exploded view;

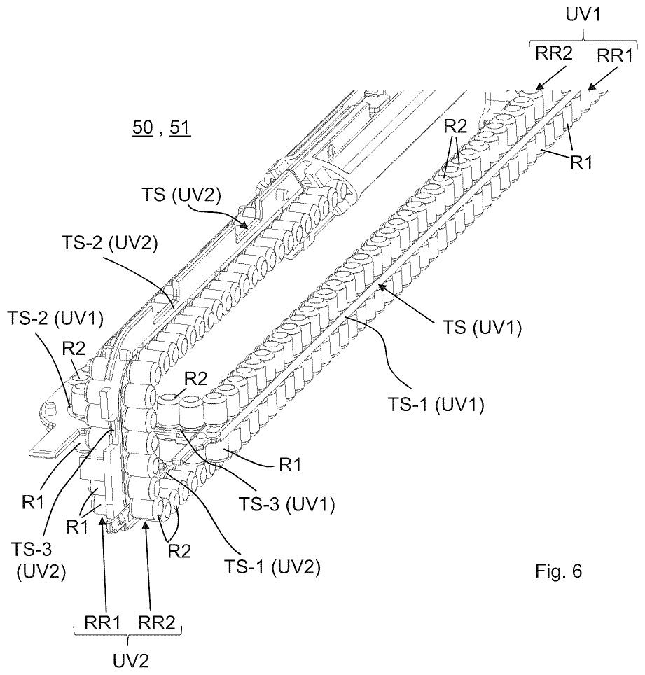

FIG. 6 shows a spatial illustration of the rows of rollers in the roller circulation channel UK1 of a roller deflection device UV1 and in the roller circulation channel UK2 of a roller deflection device UV2 according to FIGS. 2-4;

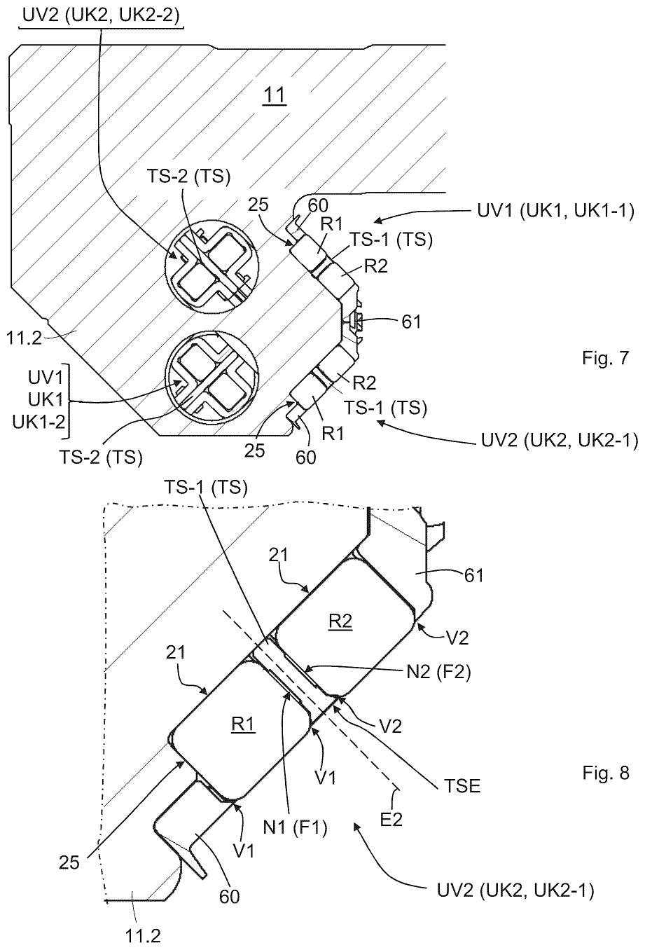

FIG. 7 shows a section of the guide carriage in a cross-section in accordance with FIG. 3, enlarged compared to FIG. 3;

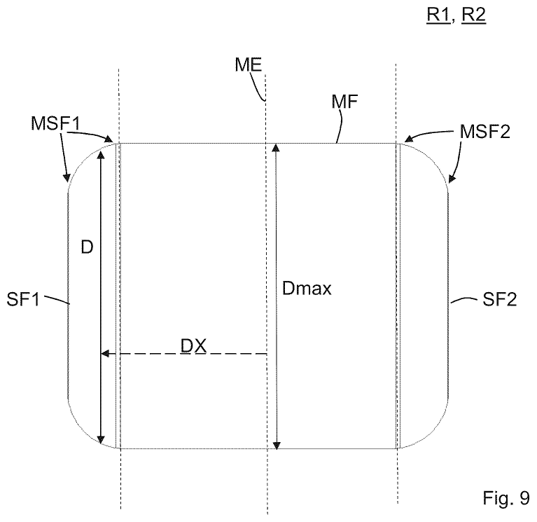

FIG. 8 shows a section of the guide carriage in a cross-section in accordance with FIG. 7, enlarged compared to FIG. 7; and FIG. 9 shows a roller of one of the roller deflection devices UV1 or UV2 in accordance with FIGS. 2-4, in a top view of the shell surface of the roller.

### DETAILED DESCRIPTION OF PREFERRED EMBODIMENTS

The same reference numbers are used for the same elements in the figures, unless otherwise stated.

FIG. 1 shows a perspective view of a linear roller profile rail guide 1 according to the invention with a profile guide rail 5 and a guide carriage 10 installed on the profile guide rail 5.

In the present example, the profile guide rail 5 comprises four flat roller running track surfaces 6, 7 extending in a longitudinal direction of the profile guide rail 5, which are spatially distributed on opposite lateral surfaces 5.1 and 5.2 of the profile guide rail 5: As can be seen from FIG. 1, on each of the lateral surfaces 5.1 or 5.2 of the profile guide rail 5, a roller running track surface 6 and a roller running track surface 7 are formed, wherein on each of the lateral surfaces 5.1 or 5.2 the respective running track surface 6 is arranged next to the respective roller running track surface 7 and extends parallel to this roller running track surface 7 with reference to the longitudinal direction of the profile guide rail 5.

With reference to a cross-section perpendicular to the profile guide rail 5, the roller running track surfaces 6 and 7 formed on the lateral surface 5.1 are arranged relative to each other in such a way that the roller running track surface 6 extends in the cross-section perpendicular to the profile guide rail 5 perpendicular to the roller running track surface 7 (as can be seen from FIG. 1 in combination with FIG. 2).

Accordingly, the roller running track surfaces 6 and 7 formed on the lateral surface 5.2 are arranged relative to each other in such a way that the roller running track surface 6 extends in the cross-section perpendicular to the profile guide rail 5 perpendicular to the roller running track surface 7 (as can be seen from FIG. 1 in combination with FIG. 2).

The guide carriage 10 is installed on the profile guide rail 5 in such a way that the guide carriage 10 is linearly moveable in the longitudinal direction of the profile guide rail 5. As can be seen from FIG. 1, the guide carriage 10 comprises, among other things, a main body 11 and two end caps 12, which are attached to the main body 11 —with reference to the longitudinal direction of the profile guide rail 5—to opposite front surfaces of the main body 11.

As can be seen from FIGS. 1 and 5, the end caps 12 each comprise a plurality of inlet openings 13, which are used to supply lubricants for lubricating rollers of the roller profile rail guide 1. A lubricant supplied through the inlet openings 13 can be transferred inside the guide carriage 10 from the end caps 12 to the rollers of the roller profile rail guide 1, which is explained in more detail below in connection with FIG. 8. Further details of the roller profile rail guide 1 are explained below with reference to FIGS. 2-9.

As can be seen from FIGS. 2 and 3, the main body 11 of the guide carriage 10 comprises a U-shaped profile with two lateral limbs 11.1 and 11.2 in a cross-section perpendicular to the longitudinal direction of the profile guide rail 5.

The cross-sectional profile of the main body 11 is shaped in such a way that if the guide carriage 10 of the profile guide rail 5 is installed as shown in FIG. 1-a n upper section of the profile guide rail 5, which includes, in particular, both the roller running track surfaces 6 and 7 formed on the lateral surface 5.1 of the profile guide rail 5 as well as the roller running track surfaces 6 and 7 formed on the lateral surface 5.2 of the profile guide rail 5, is arranged in the intermediate space between the lateral limbs 11.1 and 11.2 of the U-shaped profile of the main body 11.

The cross-sectional profile of the main body 11 is shaped in such a way that a first gap is formed between the lateral limb 11.1 of the main body 11 and the lateral surface 5.1 of the profile guide rail 5, which extends in the longitudinal direction of the profile guide rail 5. Accordingly, a second gap is formed between the lateral limb 11.2 of the main body 11 and the lateral surface 5.2 of the profile guide rail 5, which extends in the longitudinal direction of the profile guide rail 5.

The above-mentioned first gap between the lateral limb 11.1 of the main body 11 and the lateral surface 5.1 of the profile guide rail 5 and the above-mentioned second gap between the lateral limb 11.2 of the main body 11 and the lateral surface 5.2 of the profile guide rail 5 serve to accommodate those rollers of the roller profile rail guide 1 with which the guide carriage 10 is supported on the roller running track surfaces 6 and 7 of the profile guide rail 5 in order to enable movement of the guide carriage 10 in the longitudinal direction of the profile guide rail 5.

As indicated in FIG. 2, the roller profile rail guide 1 is constructed in such a way that the guide carriage 10 and the profile guide rail 5 are symmetrically formed to form a symmetry plane SE shown in FIG. 2 (the symmetry plane SE extends along the dashed line shown in FIG. 2 and designated by the reference switch in the longitudinal direction of the profile guide rail 5).

As shown in FIG. 2, on the lateral limb 11.1 of the main body 11 (on the side of the lateral limb 11.1 opposite the lateral surface 5.1 of the profile guide rail 5), two flat roller running track surfaces 20 and 21 extending in the longitudinal direction of the profile guide rail are formed.

With reference to a cross-section perpendicular to the profile guide rail 5, the roller running track surfaces 20 and 21 formed on the lateral limb 11.1 of the main body 11 are arranged next to each other in such a way that the roller running track surface 20 extends in the cross-section perpendicular to the profile guide rail 5 perpendicular to the roller running track surface 21.

As shown in FIG. 2, on the lateral limb 11.2 of the main body 11 (on the side of the lateral limb 11.2 opposite the lateral surface 5.2 of the profile guide rail 5), two flat roller running track surfaces 20 and 21 extending in the longitudinal direction of the profile guide rail are formed.

With reference to a cross-section perpendicular to the profile guide rail 5, the roller running track surfaces 20 and 21 formed on the lateral limb 11.2 of the main body 11 are arranged next to each other in such a way that the roller running track surface 20 extends in the cross-section perpendicular to the profile guide rail 5 perpendicular to the roller running track surface 21.

As shown in FIG. 2, the roller running track surfaces 20 and 21 formed on the lateral limb 11.1 of the main body 11 and the roller running track surfaces 6 and 7 formed on the lateral surface 5.1 of the profile guide rail 5 are arranged relative to each other in such a way that
the roller running track surface 6 formed on the lateral surface 5.1 of the profile guide rail 5 and the roller running track surface 20 formed on the lateral limb 11.1 of the main body 11 extend parallel to each other and are arranged opposite to each other at a distance from each other in such a way that the roller running track surface 6 formed on the lateral surface 5.1 of the profile guide rail 5 and the roller running track surface 20 formed on the lateral limb 11.1 of the main body 11 delimit a load-bearing roller passage channel LK1; and
the roller running track surface 7 formed on the lateral surface 5.1 of the profile guide rail 5 and the roller running track surface 21 formed on the lateral limb 11.1 of the main body 11 extend parallel to each other and are arranged opposite to each other at a distance from each other in such a way that the roller running track surface 7 formed on the lateral surface 5.1 of the profile guide rail 5 and the roller running track surface 21 formed on the lateral limb 11.1 of the main body 11 delimit a load-bearing roller passage channel LK2.

As shown in FIG. 2, the roller running track surfaces 20 and 21 formed on the lateral limb 11.2 of the main body 11 and the roller running track surfaces 6 and 7 formed on the lateral surface 5.2 of the profile guide rail 5 are arranged relative to each other in such a way that
the roller running track surface 6 formed on the lateral surface 5.2 of the profile guide rail 5 and the roller running track surface 20 formed on the lateral limb 11.2 of the main body 11 extend parallel to each other and are arranged opposite to each other at a distance from each other in such a way that the roller running track surface 6 formed on the lateral surface 5.2 of the profile guide rail 5 and the roller running track surface 20 formed on the lateral limb 11.2 of the main body 11 delimit a load-bearing roller passage channel LK1; and
the roller running track surface 7 formed on the lateral surface 5.2 of the profile guide rail 5 and the roller running track surface 21 formed on the lateral limb 11.2 of the main body 11 extend parallel to each other and are arranged opposite to each other at a distance from each other in such a way that the roller running track surface 7 formed on the lateral surface 5.2 of the profile guide rail 5 and the roller running track surface 21 formed on the lateral limb 11.2 of the main body 11 limit a load-bearing roller passage channel LK2.

As shown in FIG. 2, two through-holes 30 and 31 are formed in the lateral limb 11.1 of the main body 11, which are arranged next to each other, and each extends in the longitudinal direction of the profile guide rail 5.

Accordingly, two through-holes 30 and 31 are also formed in the lateral limb 11.2 of the main body 11, which are arranged next to each other, and each extends in the longitudinal direction of the profile guide rail 5.

As FIGS. 2-4 indicate, the guide carriage 10—for each of the two load-bearing roller passage channels LK1 mentioned above—comprises a full complement roller deflection device UV1 assigned to the respective individual of the load-bearing roller passage channels LK1 for two rows RR1 and RR2 of rollers arranged next to each other, which roller deflection device UV1 is attached to the main body 11 and comprises a roller circulation channel UK1 extending in a ring-shaped manner, which roller circulation channel UK1 defines a ring-shaped closed roller orbit for the rows RR1 and RR2 of rollers arranged next to each other. In the diagrams according to FIGS. 2-4, rollers arranged in the circulation channel UK1 of the roller deflection device UV1, which belong to the row RR1 of rollers, are each designated with the reference number R1; on the other hand, rollers belonging to the row RR2 of rollers are each designated with the reference number R2.

The roller deflection device UV1 is designed to be a “full complement” roller deflection device in such a way that two consecutive rollers R1 of the row RR1 are not kept at a distance relative to each other by technical means but that instead the rollers R1 can circulate in the roller circulation channel UK1 in such a way that immediately successive rollers R1 can touch each other on their shell surfaces (as can be seen from FIGS. 4 and 6). Accordingly, two consecutive rollers R2 of the row RR2 are not kept at a distance relative to each other by means of technical means; instead, the rollers R2 can circulate in the roller circulation channel UK1 in such a way that immediately successive rollers R2 can touch each other at their shell surfaces (as can be seen from FIGS. 4 and 6).

As FIGS. 2-4 also indicate, the guide carriage 10—for each of the two load-bearing roller passage channels LK2 mentioned above—comprises a full complement roller deflection device UV2 assigned to the respective individual of the load-bearing roller passage channels LK2 for two rows RR1 and RR2 of rollers arranged next to each other, which roller deflection device UV2 is attached to the main body 11 and comprises a roller circulation channel UK2 extending in a ring-shaped manner, which roller circulation channel UK2 defines a ring-shaped closed roller orbit for the rows RR1 and RR2 of rollers arranged next to each other. In the diagrams according to FIGS. 2-4, the rollers arranged in the circulation channel UK2 of the roller deflection device UV2, which belong to the row RR1 of rollers, are each designated with the reference number R1; on the other hand, rollers belonging to the row RR2 of rollers are each designated with the reference number R2.

The roller deflection device UV2 is designed to be a “full complement” roller deflection device in such a way that two consecutive rollers R1 of the row RR1 of rollers are not kept at a distance relative to each other by technical means but instead that the rollers R1 can circulate in the roller circulation channel UK2 in such a way that immediately successive rollers R1 can touch each other on their shell surfaces (as can be seen from FIG. 6). Accordingly, two consecutive rollers R2 of the row RR2 are not kept at a distance relative to each other by means of technical means; instead, the rollers R2 can circulate in the roller circulation channel UK2 in such a way that immediately successive rollers R2 can touch each other on their shell surfaces (as can be seen from FIG. 6).

As FIGS. 2-4 indicate, the roller circulation channel UK1 of the respective roller deflection device UV1 comprises: a first section UK1-1 of the roller circulation channel UK1, which is identical to the respective individual of the load-bearing roller passage channels LK1,
a second section UK1-2 of the roller circulation channel UK1, which extends at a distance from the first section UK1-1 of the roller circulation channel UK1 in the longitudinal direction of the profile guide rail 5 through one of the through-holes 30 in the main body 11,
a third section UK1-3 and a fourth section UK1-4 of the roller circulation channel UK1, wherein the third section UK1-3 of the roller circulation channel UK1 connects one of two opposite ends of the first section UK1-1 of the roller circulation channel UK1 to one of two opposite ends of the second section UK1-2 of the roller circulation channel UK1, and the fourth section UK1-4 of the roller circulation channel connects the other one of the two opposite ends of the first section UK1-1 of the roller circulation channel UK1 to the other one of the two opposite ends of the second section UK1-2 of the roller circulation channel UK1.

As FIGS. 2-4 indicate, the roller circulation channel UK2 of the respective roller deflection device UV2 comprises:
a first section UK2-1 of the roller circulation channel UK2, which is identical to the respective individual of the load-bearing roller passage channels LK2,
a second section UK2-2 of the roller circulation channel UK2, which extends at a distance from the first section UK2-1 of the roller circulation channel UK2 in the longitudinal direction of the profile guide rail 5 through one of the through-holes 31 in the main body 11,
a third section UK2-3 and a fourth section UK2-4 of the roller circulation channel UK2, wherein the third section UK2-3 of the roller circulation channel UK2 connects one of two opposite ends of the first section UK2-1 of the roller circulation channel UK2 to one of two opposite ends of the second section UK2-2 of the roller circulation channel UK2, and the fourth section UK2-4 of the roller circulation channel UK2 connects the other one of the two opposite ends of the first section UK2-1 of the roller circulation channel UK2 to the other one of the two opposite ends of the second section UK2-2 of the roller circulation channel UK2.

As FIGS. 2-4 indicate, each of the above-mentioned roller deflection devices UV1 (assigned to one of the load-bearing roller passage channels LK1) comprises at least a first row RR1 of rollers and a second row RR2 of rollers, wherein the first row RR1 of rollers comprises a plurality of rollers R1 arranged one after the other, and the second row RR2 of rollers respectively comprises a plurality of rollers R2 arranged one after the other, and the first row RR1 of rollers and the second row RR2 of rollers in the roller circulation channel UK1 of the roller deflection device UV1 are arranged next to each other in such a way that, when the guide carriage 10 moves in the longitudinal direction of the profile guide rail 5, the rollers R1 of the first row RR1 of rollers and the rollers R2 of the second row RR2 of rollers circulate next to each other along the ring-shaped closed roller orbit through the roller circulation channel UK1 in each case parallel to a specified first plane E1 (shown in FIG. 3).

As FIGS. 2 to 4 indicate, each of the above-mentioned roller deflection devices UV2 (assigned to one of the load-bearing roller passage channels LK2) comprises at least a first row RR1 of rollers and a second row RR2 of rollers, wherein the first row RR1 of rollers comprises a plurality of rollers R1 arranged one after the other, and the second row RR2 of rollers respectively comprises a plurality of rollers R2 arranged one after the other, and the first row RR1 of rollers and the second row RR2 of rollers in the roller circulation channel UK2 of the roller deflection device UV2 are arranged next to each other in such a way that, when the guide carriage 10 moves in the longitudinal direction of the profile guide rail 5, the rollers R1 of the first row RR1 of rollers and the rollers R2 of the second row RR2 of rollers circulate next to each other along the ring-shaped closed roller orbit through the roller circulation channel UK2, in each case parallel to a specified first plane E2 (shown in FIG. 3).

As FIGS. 2-4 indicate, the roller deflection device UV1 and roller deflection device UV2 are each composed of a set of individual parts. For example, sections of a roller deflection device UV1 formed on the lateral limb 11.1 or on the lateral limb 11.2 of the main body 11 extend through the through-hole 30 in the lateral limb 11.1 or in the lateral limb 11.2 of the main body 11, while other sections of a roller deflection device UV1 formed on the lateral limb 11.1 or on the lateral limb 11.2 of the main body 11 extend along the lateral limb 11.1 or on the lateral limb 11.2 along the roller running track surface 20. For example, sections of a roller deflection device UV2 formed on the lateral limb 11.1 or on the lateral limb 11.2 of the main body 11 extend through the through-hole 31 in the lateral limb 11.1 or in the lateral limb 11.2 of the main body 11, while other sections of a roller deflection device UV2 formed on the lateral limb 11.1 or on the lateral limb 11.2 of the main body 11 extend along the lateral limb 11.1 or on the lateral limb 11.2 along the roller running track surface 21.

To illustrate the spatial extension of the roller deflection devices UV1 and UV2 arranged on guide carriage 10, reference is made to FIG. 5. FIG. 5 shows the roller profile rail guide 1 in an exploded view. The diagram in accordance with FIG. 5 shows an assembly 50, which includes all parts of the roller deflection device UV1 to be arranged on the lateral limb 11.2 and all parts of the roller deflection device UV2 (detached from limb 11.2) to be arranged on the lateral limb 11.2. The diagram in accordance with FIG. 5 also shows an assembly 51, which includes all parts of the roller deflection device UV1 to be arranged on the lateral limb 11.1 and all parts of the roller deflection device UV2 to be arranged on the lateral limb 11.1 (detached from limb 11.1).

FIG. 6 illustrates the arrangement of the first row RR1 of rollers and the second row RR2 of rollers in the roller deflection devices UV1 and UV2. FIG. 6 shows an illustration of assembly 50 or assembly 51 in accordance with FIG. 5 in such a way that certain parts which form an outer wall of the roller circulation channel UK1 or an outer wall of the roller circulation channel UK2 are not shown in FIG. 6 so that in FIG. 6 the arrangement of the rollers R1 of the first row RR1 of rollers and the rollers R2 of the second row RR2 of rollers is visible in a three-dimensional illustration.

As can be seen from FIGS. 4, 5, 6-8, the roller deflection device UV1 assigned to each of the load-bearing roller passage channels LK1 comprises a separating web TS, which extends in the roller circulation channel UK1 parallel to the first plane E1 through the first section UK1-1, the second section UK1-2, the third section UK1-3 and the fourth section UK1-4 of the roller circulation channel UK1 and is arranged between the first row RR1 of rollers and the second row RR2 of rollers in such a way that the separating web TS spatially separates the rollers R1 of the first row RR1 of rollers from the rollers R2 of the second row RR2 of rollers.

The roller deflection device UV1 is attached to the main body 11 in such a way that the separating web TS of the roller deflection device UV1 is fixed relative to the main body 11 (as can be seen from FIGS. 4-6).

Accordingly, the roller deflection device UV2 assigned to each of the load-bearing roller passage channels LK2 comprises a separating web TS, which extends in the roller circulation channel UK2 parallel to the first plane E2 through the first section UK2-1, the second section UK2-2, the third section UK2-3 and the fourth section UK2-4 of the roller circulation channel UK2 and is arranged between the first row RR1 of rollers and the second row RR2 of rollers in such a way is that the separating web TS spatially separates the rollers R1 of the first row RR1 of rollers from the rollers R2 of the second row RR2 of rollers.

The roller deflection device UV2 is attached to the main body 11 in such a way that the separating web TS of the roller deflection device UV2 is fixed relative to the main body 11 (as can be seen from FIGS. 4-6).

In the present example, the separating web TS of the roller deflection device UV1 is preferably arranged in the roller circulation channel UK1 of the roller deflection device UV1 in such a way that the separating web TS extends seamlessly over the entire length of the roller circulation channel UK1 along the ring-shaped closed roller orbit for the rows RR1 or RR2 of rollers R1 or R2 arranged next to each other.

The separating web TS of the roller deflection device UV2 is preferably arranged in the roller circulation channel UK2 of the roller deflection device UV2 in such a way that the separating web TS extends seamlessly over the entire length of the roller circulation channel UK2 along the ring-shaped closed roller orbit for the rows RR1 or RR2 of rollers R1 or R2 arranged next to each other As can be seen from FIGS. 4 and 6, the separating web TS of the roller deflection device UV1 can be composed of a plurality of sections: For example, the separating web TS of the roller deflection device UV1 can have sections TS-1, TS-2, TS-3, TS-4, wherein: the section TS-1 of the separating web TS extends at least part of the length of the first section UK1-1 of the roller circulation channel UK1; the section TS-2 of the separating web TS extends across at least part of the length of the second section UK1-2 of the roller circulation channel UK1; the section TS-3 of the separating web TS extends across at least part of the length of the third section UK1-3 of the roller circulation channel UK1; and/or the section TS-4 of the separating web TS extends across at least part of the length of the fourth section UK1-4 of the roller circulation channel UK1.

Accordingly, the separating web TS of the roller deflection device UV2 can be composed of a plurality of sections: For example, the separating web TS of the roller deflection device UV2 can have sections TS-1, TS-2, TS-3, TS-4, wherein: the section TS-1 of the separating web TS extends across at least part of the length of the first section UK2-1 of the roller circulation channel UK2; the section TS-2 of the separating web TS extends at least part of the length of the second section UK2-2 of the roller circulation channel UK2; the section TS-3 of the separating web TS extends at least part of the length of the third section UK2-3 of the roller circulation channel UK2; and/or the section TS-4 of the separating web TS extends at least part of the length of the fourth section UK2-4 of the roller circulation channel UK2.

From FIGS. 4, 5, 6-8, it is furthermore evident that each roller R1 of the first row RR1 of rollers with a front surface of the respective roller R1 delimits a first lateral surface F1 of the separating web TS so that each roller R1 of the first row RR1 of rollers abuts the first lateral surface F1 of the separating web TS when the guide carriage 10 is moved in the longitudinal direction of the profile guide rail 5.

FIGS. 4, 5, 6-8 also indicate that each roller R2 of the second row RR2 of rollers with a front surface of the respective roller abuts a second lateral surface F2 of the separating web TS so that each roller of the second row R2 of rollers is guided by rollers when the guide carriage 10 moves in the longitudinal direction of the profile guide rail 5 to the second lateral surface F2 of the separating web.

As can be seen from FIGS. 3, 7 and 8, the guide carriage 10 in the present example is designed in such a way that the main body 11 comprises a first surface region 25, which extends along the first section UK1-1 of the roller circulation channel UK1 in each case parallel to the first plane E1 in such a way that, in the first section UK1-1 of the roller circulation channel UK1, rollers R1 of the first row RR1 of rollers abut the first surface region 25 of the main body 11 with a front surface of the respective roller R1 spaced away from a section TS-1 of the separating web TS, and, when the guide carriage 10 is moved in the longitudinal direction of the profile guide rail 5, are guided on the first surface region 25 of the main body 11.

Accordingly, the guide carriage 10 in the present example is designed in such a way that the main body 11 comprises a first surface region 25, which extends along the first section UK2-1 of the roller circulation channel UK2 in each case parallel to the first plane E2 in such a way that, in the first section UK2-1 of the roller circulation channel UK2, rollers R1 of the first row RR1 of rollers abut the first surface region 25 of the main body 11 with a front surface of the respective roller R1 spaced away from a section TS-1 of the separating web TS, and, when the guide carriage 10 is moved in the longitudinal direction of the profile guide rail 5, are guided on the first surface region 25 of the main body 11.

As FIGS. 8 and 9 indicate, each of the rollers R1, R2 is rotationally symmetrical with respect to a longitudinal axis of the respective roller and each roller comprises a diameter D with respect to the longitudinal axis of the roller, which comprises a variation in the direction of the longitudinal axis of the roller so that the diameter D of the roller R1, R2 in a middle area ME between opposite front surfaces SF1, SF2 of the roller and comprises a maximum value Dmax and the diameter D-starting from the middle region ME between the opposite front surfaces SF1, SF2-in the direction of the longitudinal axis of the roller as a function of a distance DX from the middle region ME shows a steadily increasing reduction with the distance DX from the middle region.

Furthermore, it can be seen that a section TS-1 of the separating web TS extends parallel to the first plane E1 in the first section UK1-1 of the roller circulation channel UK1 of the roller deflection device UV1 in such a way that the separating web —with reference to one of the roller running track surfaces 20 of the main body 11, which delimits the first section UK1-1 of the roller circulation channel UK1 of the roller deflection device UV1—comprises a height, which is less than the maximum value Dmax of the diameter of rollers R1, R2.

In addition, a section TS-1 of the separating web TS in the first section UK2-1 of the roller circulation channel UK2 of the roller deflection device UV2 extends parallel to the first plane E2 in such a way that the separating web-with reference to one of the roller running track surfaces 21 of the main body 11, which delimits the first section UK2-1 of the roller circulation channel UK2 of the roller deflection device UV2 comprises a height, which is less than the maximum value Dmax of the diameter of the rollers R1, R2.

FIG. 8 furthermore indicates that a section TS-1 of the separating web TS extends in the first section UK1-1, UK2-1 of the roller circulation channel UK1, UK2 of the roller deflection device UV1, UV2 with reference to the one of the roller running track surfaces 20, 21 of the main body 11, which delimits the first section UK1-1, UK2-1 of the roller circulation channel UK1, UK2 of the roller deflection device UV1, UV2, in such a way parallel to the first plane E1, E2 that the separating web comprises an end section TSE distanced away from the one of the roller running track surfaces 20, 21 of the main body 11.

The section TS-1 of the separating web TS comprises a first projection V1 in the spaced-away end section TSE, which extends perpendicular to the first plane E1, E2 in such a way that the first projection V1 overhangs a roller R1 of the first row RR1 of rollers, which abuts the first lateral surface F1 of the separating web TS, at an area MSF1, MSF2 of a shell surface MF of the roller R1 abutting the first lateral surface F1 of the separating web TS (FIGS. 8 and 9). In addition, section TS-1 of the separating web TS comprises a second projection V2 in the spaced-away end section TSE, which extends perpendicular to the first plane E1, E2 in such a way that the second projection V2 overhangs a roller R2 of the second row RR2 of rollers, which abuts the second lateral surface F2 of the separating web TS, at an area MSF1, MSF2 of a shell surface MF of the roller R2 abutting the second lateral surface F2 of the separating web TS (FIGS. 8 and 9).

As indicated in FIGS. 7-9, the roller deflection devices UV1, UV2 can comprise a bar 60 extending in the longitudinal direction of the profile guide rail 5, which is arranged near the surface region 25 of the main body 11 in such a way that the bar 60 abuts the front surfaces of the rollers R1 distance away from the separating web TS. The bar 60 can comprise a projection V1 which overhangs an area of a shell surface MF of the rollers R1 abutting the bar 60.

Furthermore, the roller deflection devices UV1, UV2 can comprise a bar 61 extending in the longitudinal direction of the profile guide rail 5, which is arranged in such a way that the bar 61 abuts the front surfaces of the rollers R2 spaced away from the separating web TS. The bar 61 can comprise a projection V2 which overhangs an area of a shell surface MF of the rollers R1 abutting the bar 61.

FIG. 8 indicates that the separating web TS on the first lateral surface F1 of the separating web TS comprises a first groove N1 extending along the roller circulation channel UK1, UK2, through which first groove N1 a lubricant for lubricating the rollers R1 of the first row RR1 of rollers can be introduced into the roller circulation channel UK1, UK2. Accordingly, the separating web TS comprises a second groove N2 extending along the roller circulation channel UK1, UK2 on the second lateral surface F2 of the separating web, through which second groove N2 a lubricant for lubricating the rollers R2 of the second row RR2 of rollers can be introduced into the roller circulation channel UK1, UK2.

The lubricant to be transported through the grooves N1 or N2 can be supplied to the grooves N1 or N2 via the inlet openings 13 formed in the end caps 12 (via connecting pipes, which are not shown in the figures).

Although only a few embodiments of the present invention have been shown and described, it is to be understood that many changes and modifications may be made thereunto without departing from the spirit and scope of the invention.

1. : A linear roller profile rail guide (1), comprising:
a profile guide rail (5), which has at least four flat roller running track surfaces (6, 7) extending in a longitudinal direction of the profile guide rail (5);
a guide carriage (10), which is arranged in a linearly moveable manner in the longitudinal direction of the profile guide rail (5) and comprises a main body (11) on which at least four flat roller running track surfaces (20, 21) extending in a longitudinal direction of the profile guide rail are formed;
wherein the roller running track surfaces (6, 7) of the profile guide rail (5) and the roller running track surfaces (20, 21) of the main body (11) are arranged relative to each other in such a way that one of the roller running track surfaces (6; 7) of the profile guide rail (5) and one of the roller running track surfaces (20; 21) of the main body (11) extend parallel to each other and are arranged opposite to each other at a distance from each other in such a way that the respective one of the roller running track surfaces (6; 7) of the profile guide rail (5) and the respective one of the roller running track surfaces (20; 21) of the main body (11) delimit a load-bearing roller passage channel (LK1, LK2);
wherein the guide carriage (10)-for each of the load-bearing roller passage channels (LK1, LK2)-each comprises a full complement roller deflection device (UV1, UV2) for a plurality of rows (RR1, RR2) of rollers (R1, R2) arranged next to each other, the roller deflection device being assigned to the respective individual of the load-bearing roller passage channels (LK1, LK2), wherein the roller deflection device (UV1, UV2) is attached to the main body (11) and comprises a roller circulation channel (UK1, UK2) extending in a ring-shaped manner, wherein the roller circulation channel (UK1, UK2) defines a ring-shaped closed roller orbit for the plurality of rows (RR1, RR2) of rollers (R1, R2) arranged next to each other,
wherein the roller circulation channel (UK1, UK2) of the roller deflection device (UV1, UV2) comprises:
a first section (UK1-1, UK2-1) of the roller circulation channel (UK1, UK2), which is identical to the respective one of the load-bearing roller passage channels (LK1, LK2),
a second section (UK1-2, UK2-2) of the roller circulation channel (UK1, UK2), which extends at a distance from the first section (UK1-1, UK2-1) of the roller circulation channel in the longitudinal direction of the profile guide rail,
a third section and a fourth section (UK1-3, UK2-3, UK1-4, UK2-4) of the roller circulation channel (UK1, UK2), wherein the third section (UK1-3, UK2-3) of the roller circulation channel (UK1, UK2) connects one of two opposite ends of the first section (UK1-1, UK2-1) of the roller circulation channel (UK1, UK2) to one of two opposite ends of the second section (UK1-2, UK2-2) of the roller circulation channel (UK1, UK2), and the fourth section (UK1-4, UK2-4) of the roller circulation channel connects the other one of the two opposite ends of the first section (UK1-1, UK2-1) of the roller circulation channel to the other one of the two opposite ends of the second section (UK1-2, UK2-2) of the roller circulation channel (UK1, UK2);
wherein the roller deflection device (UV1, UV2) assigned to the respective one of the load-bearing roller passage channels (LK1, LK2) comprises at least a first row (RR1) of rollers (R1) and a second row (RR2) of rollers (R2), wherein the first row (RR1) of rollers (R1) and the second row (RR2) of rollers (R2) each comprise a plurality of rollers (R1, R2) arranged one after another and the first row (RR1) of rollers and the second row (RR2) of rollers are arranged next to each other in the roller circulation channel (UK1, UK2) of the roller deflection device (UV1, UV2) in such a way that when the guide carriage (10) is moved in the longitudinal direction of the profile guide rail (5), the rollers (R1) of the first row (RR1) of rollers and the rollers (R2) of the second row (RR2) of rollers circulate next to each other along the ring-shaped closed roller orbit through the roller circulation channel (UK1, UK2), in each case parallel to a predetermined first plane (E1, E2);
wherein the full complement roller deflection device (UV1, UV2) assigned to the respective one of the load-bearing roller passage channels (LK1, LK2) comprises a separating web (TS), which is fixed relative to the main body (11) and extends in the roller circulation channel (UK1, UK2) parallel to the first plane (E1, E2) through the first section (UK1-1, UK2-1), the second section (UK1-2, UK2-2), the third section (UK1-3, UK2-3) and the fourth section (UK1-4, UK2-4) of the roller circulation channel (UK1, UK2) and is arranged between the first row (RR1) of rollers (R1) and the second row (RR2) of rollers (R2) in such a way that the separating web (TS) spatially separates the rollers (R1) of the first row (RR1) of rollers from the rollers (R2) of the second row (RR2) of rollers;
wherein each roller (R1) of the first row (RR1) of rollers abuts a first lateral surface (F1) of the separating web (TS) with a front surface (SF1, SF2) of the respective roller (R1) so that each roller (R1) of the first row (RR1) of rollers rests against the first lateral surface (F1) of the separating web (TS) when the guide carriage (10) is moved in the longitudinal direction of the profile guide rail (5), and
wherein each roller (R2) of the second row (RR2) of rollers with a front surface (SF1, SF2) of the respective roller abuts a second lateral surface (F2) of the separating web so that each roller of the second row (R2) of rollers is guided at the second lateral surface (F2) of the separating web when the guide carriage (10) moves in the longitudinal direction of the profile guide rail (5).

2. The linear roller profile rail guide (1) according to claim 1, wherein the separating web (TS) in the roller circulation channel (UK1, UK2) of the roller deflection device (UV1, UV2) is arranged in such a way that the separating web (TS) extends seamlessly over the entire length of the roller circulation channel (UK1, UK2) along the ring-shaped closed roller orbit for the rows (RR1, RR2) of rollers (R1, R2) arranged next to each other.

3. The linear roller profile rail guide (1) according to claim 1, wherein the main body (11) comprises a first surface region (25), which extends along the first section (UK1-1, UK2-1) of the roller circulation channel (UK1, UK2) in each case parallel to the first plane (E1, E2) in such a way that rollers (R1) of the first row (RR1) of rollers in the first section (UK1-1, UK2-1) of the roller circulation channel (UK1, UK2) with a front surface of the respective roller (R1) remote from the separating web (TS-1) abut the first surface region (25) of the main body (11) and in the case of a movement of the guide carriage (10) in the longitudinal direction of the profile guide rail (5) are guided at the first surface region (25) of the main body (11).

4. The linear roller profile rail guide (1) according to claim 1, wherein the roller deflection device (UV1, UV2) is composed of a plurality of individual parts and the separating web (TS) comprises a plurality of sections (TS-1, TS-2, TS-3, TS-4), wherein
one of the individual parts comprises a section of the separating web (TS-1) extending over at least part of the length of the first section (UK1-1, UK2-1) of the roller circulation channel (UK1, UK2), and/or
one of the individual parts comprises a section of the separating web (TS-2) extending over at least part of the length of the second section (UK1-2, UK2-2) of the roller circulation channel (UK1, UK2), and/or
one of the individual parts comprises a section of the separating web (TS-3) extending over at least part of the length of the third section (UK1-3, UK2-3) of the roller circulation channel (UK1, UK2), and/or
one of the individual parts comprises a section of the separating web (TS-4) extending over at least part of the length of the fourth section (UK1-4, UK2-4) of the roller circulation channel (UK1, UK2).

5. The linear roller profile rail guide (1) according to claim 1,
wherein each of the rollers (R1, R2) is designed to be rotationally symmetrical with respect to a longitudinal axis of the respective roller, and each roller comprises a diameter with respect to the longitudinal axis of the roller, which comprises a variation in the direction of the longitudinal axis of the roller so that the diameter of the roller comprises a maximum value (Dmax) in a middle area between opposite front surfaces (SF1, SF2) of the roller and the diameter—starting from the middle area between the opposite front surfaces—in the direction of the longitudinal axis of the roller, as a function of a distance from the middle area, comprises a steadily increasing reduction with the distance from the middle area; and
wherein the separating web (TS-1) extends parallel to the first plane (E1, E2) in the first section (UK1-1, UK2-1) of the roller circulation channel (UK1, UK2) of the roller deflection device (UV1, UV2) in such a way that the separating web —with reference to the one of the roller running track surfaces (20, 21) of the main body (11) which delimits the first section (UK1-1, UK2-1) of the roller circulation channel (UK1, UK2) of the roller deflection device (UV1, UV2)—comprises a height, which is less than the maximum value (Dmax) of the diameter of the rollers (R1, R2).

6. The linear roller profile rail guide (1) according to claim 5, wherein the separating web (TS-1) extends in the first section (UK1-1, UK2-1) of the roller circulation channel (UK1, UK2) of the roller deflection device (UV1, UV2) with reference to the one of the roller running track surfaces (20, 21) of the main body (11), which delimits the first section (UK1-1, UK2-1) of the roller circulation channel (UK1, UK2) of the roller deflection device (UV1, UV2), in such a way parallel to the first plane (E1, E2) that the separating web comprises an end section (TSE) spaced away from one of the roller running track surfaces (20, 21) of the main body (11);
wherein the separating web (TS-1) in the spaced-away end section (TSE) comprises a first projection (V1) extending perpendicular to the first plane (E1, E2) in such a way that the first projection (V1) overhangs a roller (R1) of the first row (RR1) of rollers abutting the first lateral surface (F1) of the separating web at an area of a shell surface (MF) of the roller abutting the first lateral surface (F1) of the separating web; and
wherein the separating web (TS-1) in the spaced-away end section (TSE) comprises a second projection (V2) which extends perpendicular to the first plane (E1, E2) in such a way that the second projection (V2) overhangs a roller (R2) of the second row (RR2) of rollers abutting the second lateral surface (F2) of the separating web (TS-1) on an area of a shell surface (MF) of the roller abutting the second lateral surface (F2) of the separating web (TS-1).

7. The linear roller profile rail guide (1) according to claim 1, wherein
the separating web (TS) on the first lateral surface (F1) of the separating web (TS) comprises a first groove (N1) extending along the roller circulation channel (UK1, UK2), through which first grove (N1) a lubricant for lubricating the rollers (R1) of the first row (RR1) of rollers can be introduced into the roller circulation channel (UK1, UK2), and/or
the separating web (TS) on the second lateral surface (F2) of the separating web comprises a second groove (N2) extending along the roller circulation channel (UK1, UK2), through which second groove (N2) a lubricant for lubricating the rollers (R2) of the second row (RR2) of rollers can be introduced into the roller circulation channel (UK1, UK2).

8. The linear roller profile rail guide (1) according to claim 1, wherein the separating web (TS) is made of plastic or at least one section (TS-1, TS-2, TS-3, TS-4) of the separating web is made of plastic.

9. The linear roller profile rail guide according to claim 1, wherein a section of the separating web (TS-1) extending in the first section (UK1-1, UK2-1) of the roller circulation channel (UK1, UK2) is made of a metallic material, such as steel.
